(19) United States
(12) Patent Application Publication
(10) Pub. No.: US 2026/0219191 A1
(43) Pub. Date: Jul. 30, 2026

(54) SYSTEMS AND METHODS TO ANALYZE MULTIMODAL SPECTROSCOPY DATA TO PROFILE SAMPLES

(71) Applicant: HyperSpectral Corp., Alexandria, VA (US)

(72) Inventors: Simi GEORGE, Alexandria, VA (US); Erik AVANISS-AGHAJANI, Alexandria, VA (US); Sarah Rachel HERNANDEZ, Austin, TX (US); Euan F. MOWAT, Alexandria, VA (US); Andrew GILBERT, Alexandria, VA (US); Mario MARTINEZ, Alexandria, VA (US); Matthew THEURER, Alexandria, VA (US)

(21) Appl. No.: 19/457,662

(22) Filed: Jan. 23, 2026

Related U.S. Application Data
(60) Provisional application No. 63/749,464, filed on Jan. 24, 2025.

(51) Int. Cl. G01N 21/65; G01N 21/35; G01N 21/3563

(52) U.S. Cl. CPC G01N 21/65; G01N 21/3563; G01N 2021/3595

(57) ABSTRACT

A method includes receiving a plurality of sets of spectrum data, each set of spectrum data associated with (1) a sample and (2) a spectrum different from remaining spectra from a plurality of spectra. For each set of spectrum data from the plurality of sets of spectrum data, the method further includes providing that set of spectrum data as input to at least one single mode machine learning model to predict a single mode feature associated with that set of spectrum data, to produce a plurality of single mode features associated with the plurality of sets of spectrum data. The plurality of single mode features is provided as input to a multimodal fusion network having a cross-attention layer to predict a cross-mode feature associated with the plurality of sets of spectrum data. A composition of the sample is determined based on the cross-mode feature.

### CROSS REFERENCE TO RELATED APPLICATIONS

This application claims priority to and the benefit of U.S. Provisional Application No. 63/749,464, filed Jan. 24, 2025, and titled “SYSTEMS AND METHODS OF DETECTING PATHOGENS USING SPECTROSCOPY AND ARTIFICIAL INTELLIGENCE,” which is incorporated herein by reference.

### FIELD

One or more embodiments described herein relate to the field of spectroscopy and, more specifically, to systems and methods configured to analyze multimodal spectra data to profile substances and/or pathogens.

### BACKGROUND

Detection tasks involving spectroscopy can be associated with, for example, drug detection (e.g., fentanyl detection and/or the like), bacteria detection (e.g., antibiotic-resistant bacteria detection, and/or the like), other pathogen detection (e.g., viral detection and/or the like), and/or etc.

Antibiotic-resistant bacteria, including, for example, methicillin-resistant Staphylococcus aureus (MRSA) and Mycobacterium tuberculosis (MDR-TB), represent a growing global health threat, driving significant morbidity, mortality, and healthcare expenditures. In parallel, the frequent emergence of foodborne pathogens (e.g., Listeria monocytogenes, Escherichia coli, Salmonella enterica, and/or etc.) underscores the importance of continuous, cost-effective surveillance. Unfortunately, some known detection methods are time-consuming and labor-intensive, delaying appropriate interventions. For example, molecular approaches such as 16S rRNA gene sequencing are constrained by time (e.g., due to culture and/or sequencing), cost, and/or infrastructure requirements.

More specifically, some known culture-based tests, such as biochemical assays, have historical validation and are relatively straightforward to interpret outcomes. These culture-based tests, however, can span at least one to three days to generate results, and in the case of slow-growing organisms such as Mycobacterium tuberculosis, can extend to several weeks, substantially delaying definitive treatment. Furthermore, cultures can be highly sensitive to growth conditions; even slight variations in temperature, medium composition, or incubation time can lead to false negatives, ultimately increasing the risk of underdiagnosis and/or misdiagnosis. Beyond these issues, some known culture-based testing involves considerable laboratory space and skilled personnel to oversee the lengthy incubation periods and interpret results accurately.

Other known detection methods include Matrix-Assisted Laser Desorption/Ionization-Time-Of-Flight (MALDI-TOF) mass spectrometry, which identifies bacteria by analyzing the characteristic mass spectrometric profiles of proteins (often ribosomal proteins). This method is relatively rapid, typically involving about one hour after colony isolation, and can offer high species-level accuracy at a comparatively low reagent cost. Despite these advantages, however, reliable spectra depend on obtaining pure colonies and accurate organism identification depends on maintaining an up-to-date reference database.

Turning to some known nucleic-acid based methods, these methods (e.g., Polymerase Chain Reaction (PCR)) are highly sensitive and specific and are therefore useful in clinical laboratories. More specifically, Real-Time PCR (qPCR), for example, can deliver results in 2-6 hours, which is faster than traditional PCR, though primer design limitations can hinder the detection of novel strains. Next-Generation Sequencing (NGS) offers comprehensive genomic insights, but NGS's reliance on sophisticated infrastructure and higher costs typically translates to a 24-48-hour turnaround.

Yet other known detection methods include rapid immunoassays (e.g., performed by lateral flow devices), which can provide results in 15-30 minutes and are user-friendly, though these methods often target a single pathogen and exhibit modest sensitivity. Some known automated blood culture systems speed up initial detection of bloodstream infections but still depend on culture growth for definitive identification.

Turning to drug detection, the fentanyl crisis, for example, has escalated to an alarming level in the United States, causing over 100,000 annual overdose-related deaths, approximately two-thirds of which involve synthetic opioids such as fentanyl. Law enforcement can benefit from rapidly linking disparate seized synthetic opioid samples to a single source and identifying specific manufacturing routes. Some known forensic approaches involve transporting samples to a central lab and often take days or weeks to generate results. This delay severely hampers agencies like U.S. Customs and Border Protection (CBP), Immigration and Customs Enforcement (ICE), and/or etc., in on-site interdictions and/or bust operations, where contemporaneous intelligence can help disrupt active trafficking networks.

Moreover, when fentanyl (and/or the like) is seized at a border checkpoint or discovered during an on-site drug bust, agents should act quickly to pinpoint the supplier, map out the synthetic routes, and identify connections to previous seizures in other jurisdictions. Unfortunately, some known methods involve off-site laboratory infrastructure that causes critical lags before enforcement agencies can coordinate, link cases, and/or secure prosecutions. A lack of a unified cross-agency intelligence-sharing framework also complicates efforts to track evolving trafficking patterns in real time.

A need exists, therefore, for systems and methods configured to facilitate rapid and accurate detection and profiling of a sample without involving complex processes and/or infrastructure (e.g., culturing, specialized reagents, and/or etc.).

### SUMMARY

According to an embodiment, a non-transitory, processor-readable medium stores instructions that, when executed by a processor, cause the processor to receive a plurality of sets of spectrum data, each set of spectrum data associated with (1) a sample and (2) a spectrum different from remaining spectra from a plurality of spectra. The instructions further cause the processor to, for each set of spectrum data from the plurality of sets of spectrum data, provide that set of spectrum data as input to at least one single mode machine learning model to predict a single mode feature associated with that set of spectrum data, to produce a plurality of single mode features associated with the plurality of sets of spectrum data. The plurality of single mode features is provided as input to a multimodal fusion network having a cross-attention layer to predict a cross-mode feature associated with the plurality of sets of spectrum data. A composition of the sample is determined based on the cross-mode feature.

According to an embodiment, a non-transitory, processor-readable medium stores instructions that, when executed by a processor, cause the processor to receive spectrum data associated with a sample and provide the spectrum data as input to a first machine learning model to produce dominant spectral variation data having a lower dimensionality than the spectrum data. The instructions further cause the processor to provide the dominant spectral variation data as input to a second machine learning model to produce embedded data that represents at least one feature of the spectrum data. The embedded data is provided as input to a third machine learning model to classify the sample.

According to an embodiment, a non-transitory, processor-readable medium stores instructions that, when executed by a processor, cause the processor to receive a plurality of sets of spectrum data, each set of spectrum data associated with (1) a sample and (2) a spectrum different from remaining spectra from a plurality of spectra. The instructions further cause the process to generate a model based on at least one set of spectrum data from the plurality of sets of spectrum data. Spectral deconvolution is performed on at least one set of spectrum data from the plurality of sets of spectrum data by (1) convolving the model based on at least one of a point spread function associated with the at least one set of spectrum data or an impulse response associated with the at least one set of spectrum data, to produce a convoluted model, and (2) producing deconvoluted spectrum data based on the convoluted model. The deconvoluted spectrum data is provided as input to a multimodal fusion network having a cross-attention layer to predict a cross-mode feature associated with the plurality of sets of spectrum data, and a composition of the sample is determined based on the cross-mode feature.

### BRIEF DESCRIPTION OF THE DRAWINGS

FIG. 1 shows a system block diagram of a spectroscopy analysis system, according to an embodiment.

FIG. 2 shows a system block diagram of a compute device included in a spectroscopy analysis system, according to an embodiment.

FIG. 3 shows a system block diagram of multimodal analysis components included in a spectroscopy analysis system, according to an embodiment.

FIG. 4 shows a flow diagram illustrating a method for performing multimodal analysis of a sample, according to an embodiment.

FIG. 5 shows a system block diagram of multimodal analysis layers implemented by a spectroscopy analysis system, according to an embodiment.

FIG. 6 shows a flow diagram illustrating an example hierarchical dataflow between federal, state, and local agency compute devices, according to an embodiment.

FIG. 7 shows a system block diagram of hybrid analysis components included in a spectroscopy analysis system, according to an embodiment.

FIG. 8 shows a confusion matrix that represents performance of a machine learning model(s) associated with a spectroscopy analysis system, according to an embodiment.

FIG. 9 shows a representation of strains of antibiotic-resistant tuberculosis bacteria analyzed by a spectroscopy analysis system, according to an embodiment.

FIG. 10 shows a flow diagram illustrating a method for determining a composition of a sample based on a cross-mode feature, according to an embodiment.

FIG. 11 shows a flow diagram illustrating a method for classifying a sample based on Raman spectrum data, according to an embodiment.

FIG. 12 shows a flow diagram illustrating a method for determining a composition of a sample based on deconvoluted spectrum data, according to an embodiment.

FIG. 13 shows a graph of Raman spectral profiles for five strains of Staphylococcus aureus, according to an embodiment.

### DETAILED DESCRIPTION

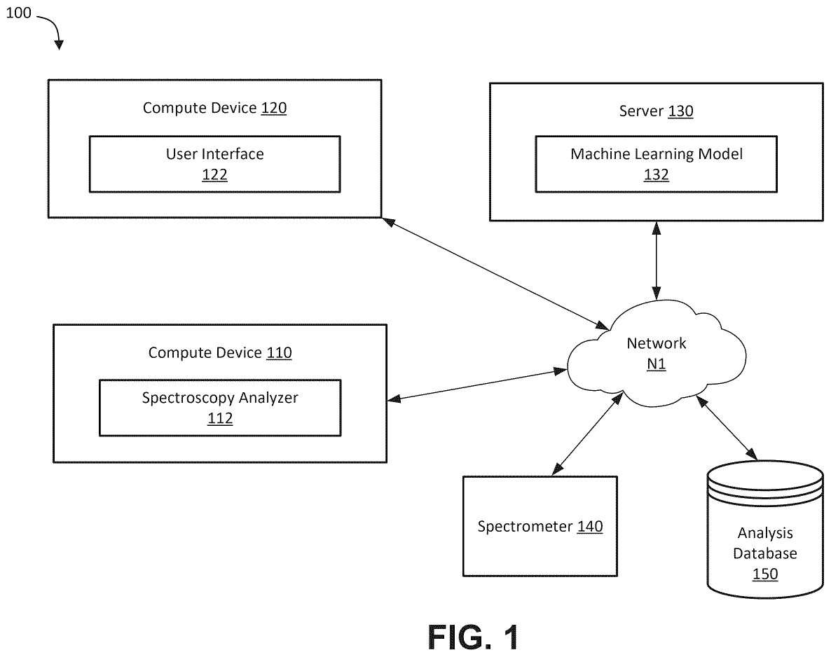

FIG. 1 shows a system block diagram of a spectroscopy analysis system 100, according to an embodiment. The spectroscopy analysis system 100 includes a compute device 110, a compute device 120, a server 130, a spectrometer 140, an analysis database 150, and a network N1. The spectroscopy analysis system 100 can include alternative configurations, and various steps and/or functions of the processes described below can be shared among the various devices of the spectroscopy analysis system 100 or can be assigned to specific devices (e.g., the compute device 110, the compute device 120, the server 130, and/or the like) different from the descriptions herein. For example, in some configurations, a user can provide inputs (as described herein) directly to the compute device 110 rather than via the compute device 120.

In some implementations, the compute device 110, the compute device 120, and/or the server 130 can include any suitable hardware-based computing devices and/or multimedia devices, such as, for example, a server, a desktop compute device, a smartphone, a tablet, a wearable device, a laptop and/or the like. In some implementations, the compute device 110, the compute device 120, and/or the server 130 can be implemented at an edge (e.g., with respect to the network N1) node or other remote (e.g., with respect to the network N1) computing facility and/or device. In some implementations, each of the compute device 110, the compute device 120, and/or the server 130 can be (or be included in) a data center or other control facility and/or device configured to run and/or execute a distributed computing system and can communicate with other compute devices.

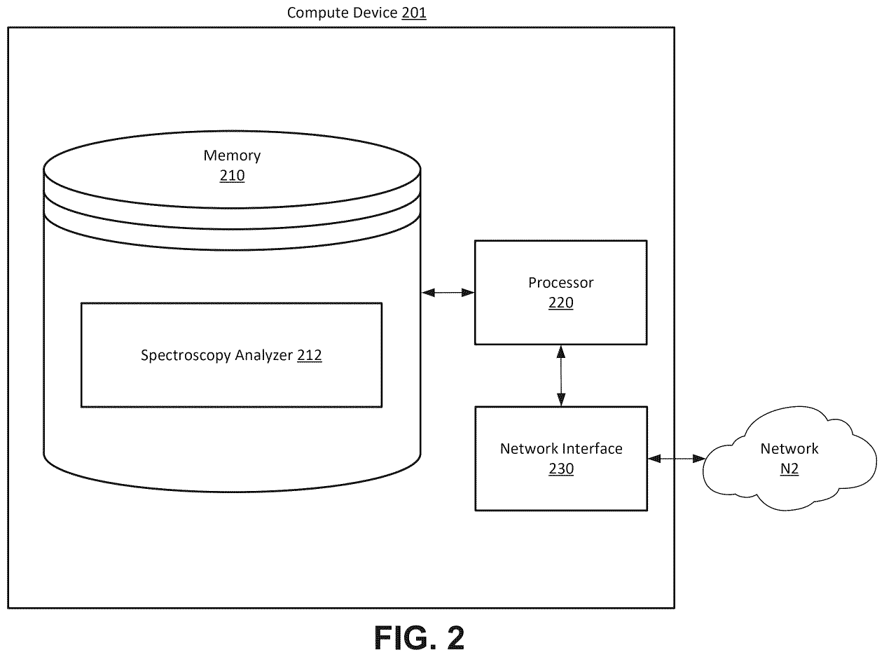

The compute device 110 can include a spectroscopy analyzer 112, which can include software (1) stored at a memory that is functionally and/or structurally similar to the memory 210 of FIG. 2 discussed below and (2) executed via a processor that is functionally and/or structurally similar to the processor 220 of FIG. 2 discussed below. The spectroscopy analyzer 112 can be configured to analyze spectra data produced by the spectrometer 140 (described herein) to, for example, identify a substance (e.g., fentanyl and/or etc.) and/or a pathogen (e.g., an antibiotic-resistant pathogen and/or a foodborne pathogen), as described herein. The spectroscopy analyzer 112 can be functionally and/or structurally similar to the spectroscopy analyzer 212 of FIG. 2.

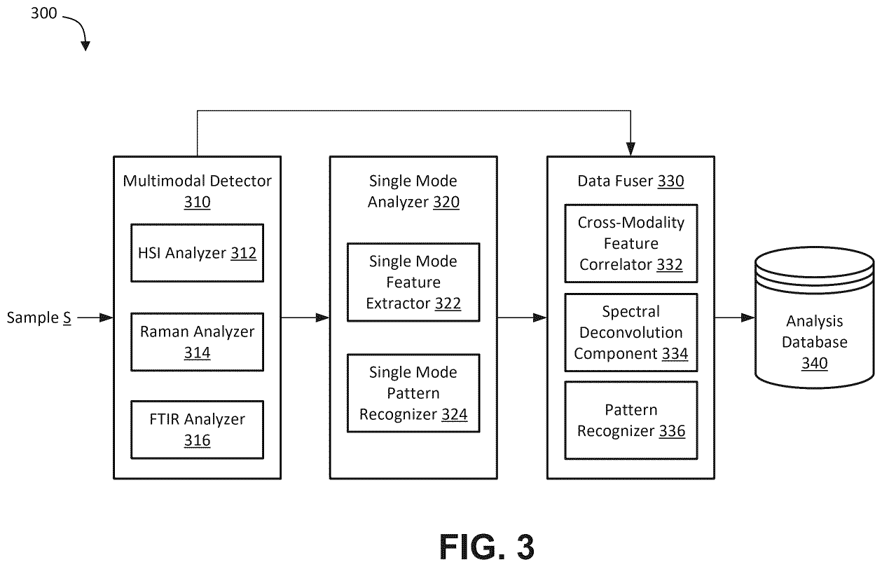

The compute device 120 can implement a user interface 122, which can include a programmatic interface (e.g., an application programming interface (API), a graphical user interface (GUI) (e.g., displayed on a monitor/display), and/or etc.) that is configured to receive input data (e.g., similar to the input data 302 of FIG. 3) from a user. The user interface 122 can further cause return and/or display of output data generated by the spectroscopy analyzer 112 (e.g., based on persistent data produced by the spectroscopy analyzer 112, as described herein). The user interface 122 can be implemented via software and/or hardware.

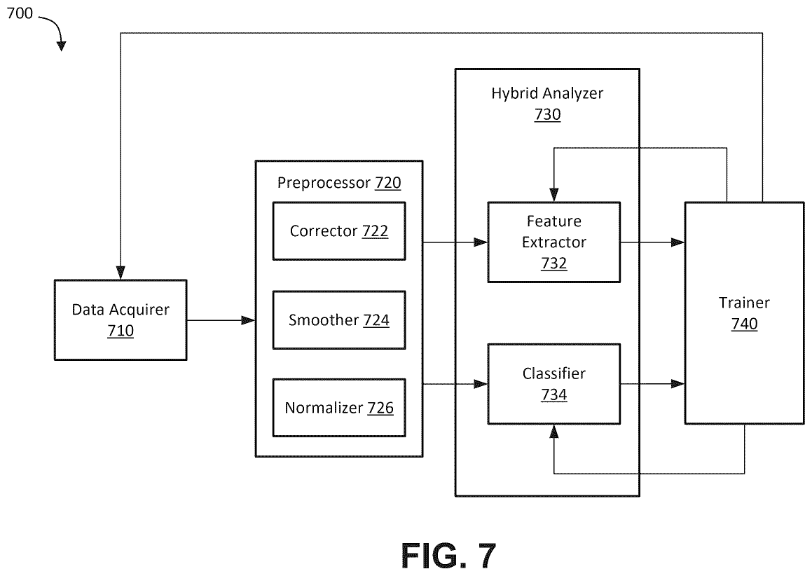

The server 130 can include a remote (e.g., as to the compute device 110 and/or the compute device 120) compute device(s) that can be configured to train, host, and/or execute a machine learning model 132. The machine learning model 132 can be functionally and/or structurally similar to the single mode feature extractor 322 and/or the cross-modality feature correlator 332 of FIG. 3 and/or the feature extractor 732 and/or the classifier 734 of FIG. 7 (each described herein). The machine learning model 132 can include, for example, a feedforward neural network, a convolutional neural network, a support vector machine (SVM), a random forest, an autoencoder, and/or etc., as described further herein. In some implementations, the compute device 110 can execute a service (e.g., a prompt service) to provide input data to the machine learning model 132. Alternatively or in addition, although not shown in FIG. 1, the compute device 110 can train, host, and/or execute the machine learning model 132.

The spectrometer 140 can be configured to perform spectroscopy (e.g., Raman spectroscopy, Fourier transform infrared spectroscopy (FTIR), and/or etc.), spectrometry, hyperspectral imaging (HSI), and/or the like, to produce spectrum data, as described herein. The spectrometer 140 can be, for example, associated with the HSI analyzer 312, the Raman analyzer 314, and/or the FTIR analyzer 316 of FIG. 3, each described herein.

The analysis database 150 can store results (e.g., sample profile predictions) produced by the spectroscopy analyzer 112 and/or the machine learning model 132. The analysis database 150 can be functionally and/or structurally similar to the analysis database 340 of FIG. 3, described herein.

The compute device 110 can be networked and/or communicatively coupled to the compute device 120, the server 130, the spectrometer 140, and/or the analysis database 150, via the network N1, using wired connections and/or wireless connections. The network N1 can include various configurations and protocols, including, for example, short range communication protocols, Bluetooth®, Bluetooth® LE, the Internet, World Wide Web, intranets, virtual private networks, wide area networks, local networks, private networks using communication protocols proprietary to one or more companies, Ethernet, WiFi® and/or Hypertext Transfer Protocol (HTTP), cellular data networks, satellite networks, free space optical networks and/or various combinations of the foregoing. Communication can be facilitated by any device capable of transmitting data to and from other compute devices, such as a modem(s) and/or a wireless interface(s).

In some implementations, although not shown in FIG. 1, the spectroscopy analysis system 100 can include multiple compute devices 110, compute devices 120, and/or servers 130. For example, in some implementations, the spectroscopy analysis system 100 can include multiple compute devices 110, where each compute device 110 can be associated with a different user from multiple users. In some implementations, multiple compute devices 110 can be associated with a single user, where each compute device 110 can be associated with, for example, a different input modality (e.g., text input, audio input, analog and/or digital signal input, image input, video input, etc.). Some implementations can include various combinations of the above.

FIG. 2 shows a system block diagram of a compute device 201 included in a spectroscopy analysis system, according to an embodiment. The compute device 201 can be structurally and/or functionally similar to, for example, the compute device 110 of the spectroscopy analysis system 100 shown in FIG. 1. The compute device 201 can be a hardware-based computing device, a multimedia device, or a cloud-based device such as, for example, a computer device, a server, a desktop compute device, a laptop, a smartphone, a tablet, a wearable device, a remote computing infrastructure, and/or the like. The compute device 201 includes a memory 210, a processor 220, and a network interface 230 operably coupled to a network N2.

The processor 220 can be, for example, a hardware-based integrated circuit (IC), or any other suitable processing device configured to run and/or execute a set of instructions or code (e.g., stored in memory 210). For example, the processor 220 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a graphics processing unit (GPU), a programmable logic controller (PLC), a remote cluster of one or more processors associated with a cloud-based computing infrastructure and/or the like. The processor 220 is operatively coupled to the memory 210. In some implementations, for example, the processor 220 can be coupled to the memory 210 through a system bus (for example, address bus, data bus and/or control bus). In some implementations, the processor 220 can include multiple parallelly arranged processors.

The memory 210 can be, for example, a random-access memory (RAM), a memory buffer, a hard drive, a read-only memory (ROM), an erasable programmable read-only memory (EPROM), and/or the like. The memory 210 can store, for example, one or more software modules and/or code that can include instructions to cause the processor 220 to perform one or more processes, functions, and/or the like. In some implementations, the memory 210 can be a portable memory (e.g., a flash drive, a portable hard disk, and/or the like) that can be operatively coupled to the processor 220. In some instances, the memory can be remotely operatively coupled with the compute device 201, for example, via the network interface 230. For example, a remote database server can be operatively coupled to the compute device 201.

The memory 210 can store various instructions associated with processes, algorithms and/or data, as described herein. Memory 210 can further include any non-transitory computer-readable storage medium for storing data and/or software that is executable by processor 220, and/or any other medium, which may be used to store information that may be accessed by processor 220 to control the operation of the compute device 201. For example, the memory 210 can store data associated with a spectroscopy analyzer 212. The spectroscopy analyzer 212 can be configured to analyze spectra data produced by the spectrometer 140 (described herein) to, for example, identify a substance (e.g., fentanyl and/or etc.) and/or a pathogen (e.g., an antibiotic-resistant pathogen and/or a foodborne pathogen), as described herein. The spectroscopy analyzer 212 can be functionally and/or structurally similar to the spectroscopy analyzer 112 of FIG. 1.

The network interface 230 can be configured to connect to the network N2, which can be functionally and/or structurally similar to the network N1 of FIG. 1. For example, network N2 can use any of the communication protocols described above with respect to network N1 of FIG. 1. In some implementations, the network interface 230 can include a network interface controller (NIC) that implements a physical and/or data link layer (e.g., Ethernet, Wi-Fi®, etc.).

In some instances, the compute device 201 can further include a display, an input device, and/or an output interface (not shown in FIG. 2). The display can be any display device (e.g., a monitor, screen, etc.) by which the compute device 201 can output and/or display data (e.g., via a user interface that is structurally and/or functionally similar to the user interface 122 of FIG. 1). The input device can include, for example, a mouse, keyboard, touch screen, voice interface, and/or any other hand-held controller or device or interface via which a user may interact with the compute device 201. The output interface can include, for example, a bus, port, and/or other interfaces by which the compute device 201 may connect to and/or output data to other devices and/or peripherals.

FIG. 3 shows a system block diagram of multimodal analysis components 300 included in a spectroscopy analysis system, according to an embodiment. At least a portion of the multimodal analysis components 300 can be associated with a compute device (e.g., a compute device that is structurally and/or functionally similar to the compute device 201 of FIG. 2 and/or the compute devices 110 and 120 of FIG. 1). For example, the multimodal analysis components 300 can include, be included in, implement, and/or be associated with (1) the spectroscopy analyzer 112 of FIG. 1 and/or (2) the spectroscopy analyzer 212 of FIG. 2. In some instances, the multimodal analysis components 300 can include software stored in memory 210 and configured to execute via the processor 220 of FIG. 2. In some instances, at least a portion of the multimodal analysis components 300 can be implemented in hardware (e.g., an ASIC) or a combination of hardware (e.g., a general-purpose processor) and software.

The multimodal analysis components 300 receive a sample S (and/or data that represents the sample S) and include and/or have access to a multimodal detector 310, a singe mode analyzer 320, a data fuser 330, and an analysis database 340 (e.g., functionally and/or structurally similar to the analysis database 150 of FIG. 1). The multimodal detector 310 includes a hyperspectral imaging (HSI) analyzer 312, a Raman analyzer 314, and a Fourier transform infrared spectroscopy (FTIR) analyzer 316. The single mode analyzer 320 includes a single mode feature extractor 322 and a single mode pattern recognizer 324. The data fuser 330 includes a cross-modality feature correlator 332, a spectral deconvolution component 334, and a pattern recognizer 336.

The sample S can include, for example, a raw sample of a drug (e.g., fentanyl), a pathogen, and/or another substance, material, microorganism, and/or the like to be profiled. The sample S can undergo parallel analysis via the components of the multimodal detector 310 (e.g., the HSI analyzer 312, the Raman analyzer 320, and/or the FTIR analyzer 316). At a high level, each component of the multimodal detector 310 can be configured to perform spectroscopy at different wavelengths, frequencies, energies, and/or etc. As a result, the multimodal detector 310 can produce data that represents a plurality of spectrums. More specifically, as described further herein for each component, the HSI analyzer 312 can perform miniaturized hyperspectral imaging to capture spatial chemical distribution within the sample S (e.g., to capture fentanyl and/or cutting agents) in near-microscopic detail. The Raman analyzer 320 can provide molecular-level fingerprinting of the sample S (e.g., fingerprinting of fentanyl analogs and/or precursor chemicals). The FTIR analyzer 316 can pinpoint functional groups and/or polar bonds to, for example, reveal unique synthetic routes.

Turning to the HSI analyzer 312 in further detail, this component can provide spatial distribution mapping of chemical components across the surface (e.g., the entire surface) of the sample S. The HSI analyzer 312 can therefore detect heterogeneous mixing patterns that are characteristic of, for example, specific drug manufacturing processes. In some implementations, the HSI analyzer 312 can perform HSI to identify subtle variations in chemical composition that can indicate different synthetic routes and/or production batches. Additionally, HSI's non-destructive nature can preserve evidence for further forensic analysis while providing rapid initial screening. By capturing spectral bands (e.g., hundreds of spectral bands) simultaneously, concurrently, and/or contemporaneously, the HSI analyzer 312 can facilitate detection of, for example, trace compounds and/or cutting agents that can otherwise be missed by some known single-point analysis methods.

An example wavelength in the range of, for example, 400-1700 nm (e.g., a continuous wavelength band having steps of, for example, 1 nm) can be associated with HSI performed by the HSI analyzer 312. In some implementations, the HSI analyzer 312 can produce a hyperspectral image (represented by hyperspectral image data) that represents a wavelength spectrum for each pixel from a plurality of pixels of the hyperspectral image. In some implementations, the HSI analyzer 312 can be performed by an HSI device that employs micro-electro-mechanical systems (MEMS) based miniaturization (e.g., by integrating optical components like micromirrors and/or scanners onto silicon chips) to cause the HSI device to have a smaller (e.g., 40% smaller than a non-MEMS HSI device) and more portable form factor.

Turning now to the Raman analyzer 314, this component can be configured to perform and/or analyze data from Raman spectroscopy, which can include a label-free, non-destructive technique based on inelastic scattering of monochromatic light. The Raman analyzer 314 can perform molecular fingerprinting of the sample S and/or analogs of the sample S. Raman spectroscopy's ability to detect specific molecular vibrations can permit the Raman analyzer 314 to provide definitive identification of chemical structures to distinguish between similar derivatives (e.g., fentanyl derivatives). In some implementations, Raman spectroscopy's high specificity can also allow for detection of subtle molecular differences that separate, for example, legal pharmaceutical compounds from illicit variants. Raman spectroscopy's capability to analyze samples through transparent packaging materials (like plastic bags and/or glass vials) can be particularly useful for rapid field testing while maintaining evidence integrity. Alternatively or in addition, Raman spectroscopy's sensitivity to crystal structure can provide insights into drug manufacturing processes, as different crystallization methods can produce distinct Raman signatures.

An example excitation wavelength of 785 nm and/or an example resolution of 4 cm⁻¹ can be associated with Raman spectroscopy performed by the Raman analyzer 314. By optimizing (or improving) wavelength selection, the Raman analyzer 314 can facilitate a reduction (e.g., a 3× reduction) in fluorescence interference.

The FTIR analyzer 316 can be configured to provide molecular structure information that is complimentary to and determined through different physical principles than information determined by the HSI analyzer 312 and/or the Raman analyzer 314. The FTIR analyzer 316 can be configured to perform FTIR to identify functional groups. In some instances, FTIR can be particularly sensitive to polar bonds and can therefore be suitable in at least some instances for detecting, for example, cutting agents and/or synthetic precursors used in the production of, for example, fentanyl and/or the like. In at least some instances, the FTIR analyzer 316 can use FTIR to analyze both organic and inorganic compounds to create a complete chemical profile (e.g., chemical composition) of the sample S. FTIR's high sensitivity to hydrogen bonding patterns can also reveal information about purity and/or crystallinity of the sample S, which can be linked to specific manufacturing processes. Additionally, spectral libraries associated with FTIR can enable rapid comparison with, for example, known fentanyl variants and common adulterants.

The FTIR analyzer 316 can be associated with a spectral range of, for example, about 400-4000 cm⁻¹ and/or can have an example resolution of about 4 cm⁻¹. In some instances, the FTIR analyzer 316 can be configured to perform pressure-free ATR sampling. In some implementations, the FTIR analyzer 316 can analyze the sample S without prior preparation of the sample S.

By receiving sets of spectrum data from, respectively, the HSI analyzer 312, the Raman analyzer 314, and the FTIR analyzer 316, the multimodal detector 310 can facilitate a synergistic effect that can overcome at least some limitations of at least some of the individual components of the multimodal detector 310. More specifically, the multimodal detector 310 can promote cross-validation as a result of each component providing confirmation of chemical identification, reducing false positives and reducing false negatives. In some implementations, the multimodal detector 310 can be configured to perform adaptive analysis by emphasizing data from the most appropriate component based on sample characteristics (e.g., using data from the FTIR analyzer 316 for highly fluorescent samples that might challenge the Raman analyzer 314). In some implementations, the multimodal detector 310 can produce complementary information. For example, the HSI analyzer 312 can be configured to produce spatial distribution data, the Raman analyzer 314 can be configured to determine molecular fingerprinting, and the FTIR analyzer 316 can produce functional group information. As a result, these components can collectively produce a comprehensive chemical profile. In some instances, the combined data produced by the multimodal detector 310 can further provide insights into synthesis routes, cutting agents, production methods, and/or the like, associated with the sample S.

Turning to the single mode analyzer 320, this component can be configured to separately analyze individual spectra (each represented by a set of spectrum data) produced by the HSI analyzer 312, the Raman Analyzer 314, and/or the FTIR analyzer 316. For example, the single mode feature extractor 322 can include a convolutional neural network (CNN), a recurrent neural network (RNN), and/or another single mode machine learning model, configured to classify the spectrum data to identify a single mode feature(s) (e.g., a classification of a type associated with the sample S, a classification of a characteristic of the sample S, and/or etc., as represented by the given spectrum). The single model pattern recognizer 324 can be configured to reference predefined patterns to identify the patterns in a spectrum. For example, for an HSI spectrum, the single model pattern recognizer 324 can detect heterogeneous mixing patterns characteristic of specific drug manufacturing processes and/or identify subtle variations in chemical composition that may indicate different synthetic routes or production batches. For an FTIR spectrum (represented by FTIR spectrum data), the single model pattern recognizer 324 can identify hydrogen bonding patterns that indicate drug purity and/or crystallinity, which can be linked to specific manufacturing processes.

After the single mode analyzer 320 classifies spectra individually, the data fuser 330 can classify the spectra collectively and/or concurrently. More specifically, the cross-modality feature correlator 332 can include a feed-forward neural network and/or the like and a spectral adaptation layer that implements a specialized (e.g., as to spectral analysis) attention mechanism. Collectively, the feed-forward network and the spectral adaptation layer can implement a multimodal fusion network that performs cross-attention (e.g., via a cross-attention layer) between different modalities (e.g., between different spectra produced by the multimodal detector 310). The cross-modality feature correlator 332 can perform this cross-attention by progressively reducing dimensionality (d) of the spectra [e.g., 2d, d, d/2], effectively distilling the cross-modal information represented by the spectra into a compact (e.g., memory efficient) yet informative representation (e.g., a vector representation or other embedded representation).

Examples of features determined by the cross-modality feature correlator 332 include, for example, chemical markers and/or physical characteristics of the sample S. In some implementations, the cross-modality feature correlator 332 can be configured to perform comprehensive source attribution through detailed analysis of the chemical markers and/or physical characteristics. Chemical marker analysis can involve examining synthesis route indicators, cutting agent signatures, trace element profiles, and/or isotopic ratios. Physical characteristics assessment can include crystal morphology analysis, tablet pressing patterns, microscopic surface features, and/or packaging material analysis. These combined capabilities can permit the cross-modality feature correlator 332 to identify and track the origins of the sample S.

Turning to other components of the data fuser 330, the spectral deconvolution component 334 can be configured to identify trace adulterants and/or precursors associated with the sample S. More specifically, in some implementations, the spectral deconvolution component 334 can receive spectral data from the multimodal detector 310 (e.g., from one or more of the HSI analyzer 312, the Raman analyzer 314, and/or the FTIR analyzer 316). In some implementations, although not shown in FIG. 3, the spectral deconvolution component 334 can resolve spectral data (as described below) before providing the resulting resolved spectral data to the single model analyzer 320.

In use, the spectral deconvolution component 334 can separate signals that are associated with a primary substance and the adulterants/precursor and that have been mixed (convolved) in the physical domain (e.g., as a result of multiple compounds eluting together, light blurring, and/or etc.). More specifically, the spectral deconvolution component 334 can generate a model of ideal and/or separate peaks (e.g., Gaussian and/or Lorentzian shapes) based on the spectra from the multimodal detector 310. The spectral deconvolution component 334 can mathematically convolve (blur/combine) the model (to produce a convoluted model) based on the predetermined response for a given of the spectrometer(s) (e.g., point spread function and/or impulse response associated with the spectrometer(s)) that captured the spectra (e.g., via the multimodal detector 310). The spectral deconvolution component 334 can then adjust the parameters (e.g., position, height, width) of the model peaks until the simulated, convoluted spectrum matches (e.g., within a predefined threshold) a raw, observed, and distorted spectra from the multimodal detector 310. The final parameters of the adjusted model peaks can represent the centers, intensities, and shapes of the original, unblurred components.

The pattern recognizer 336 can be configured to reference predefined patterns to identify the patterns in the collective spectra to, for example, identify chemical signatures tied to specific manufacturing routes and/or perform batch differentiation.

Following analysis of the sample S, the analysis results from the data fuser 330 can be stored at the analysis database 340. As described further herein, the stored data can be shared under hierarchical access control through federal-level oversight dashboards, state-level coordination interfaces, local agency access points, and/or configurable sharing permissions based on jurisdiction and security clearance.

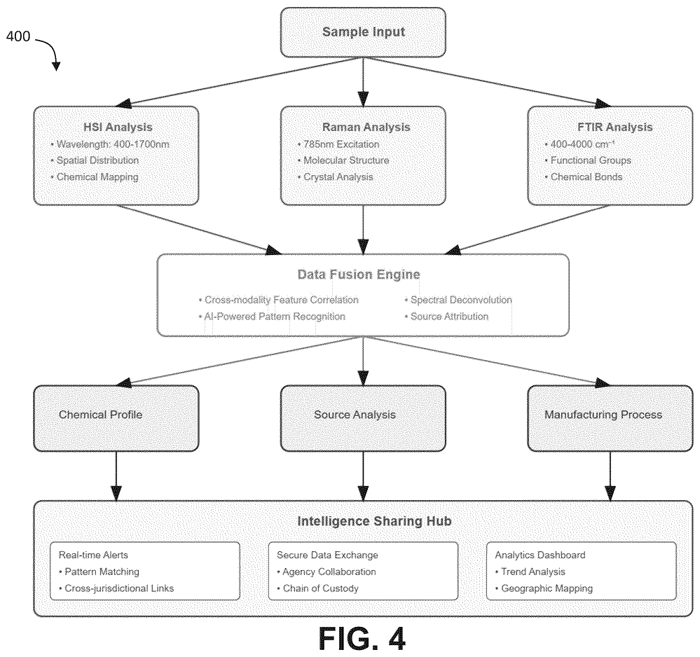

FIG. 4 shows a flow diagram illustrating a method 400 for performing multimodal analysis of a sample, according to an embodiment. In some instances, the method 400 can be implemented by a spectroscopy analysis system (e.g., the spectroscopy analysis system 100 of FIG. 1). Portions of the method 400 can be implemented using a processor (e.g., the processor 220 of FIG. 2) of any suitable compute device (e.g., the compute device 201 of FIG. 2 and/or the compute devices 110 and/or 120 and/or the server 130 of FIG. 1). As described herein, the method 400 can integrate complementary analytical technologies, each optimized for a detection task (e.g., fentanyl detection) and serving a role in comprehensive sample analysis.

As illustrated in FIG. 4, once a raw sample is collected, the sample can undergo parallel HSI, Raman, and FTIR detection and analysis, each contributing unique spectral data. It will be appreciated that any or all of these analyses can be applied as part of the method 400.

As shown in FIG. 4, as part of the method 400, an artificial intelligence (AI) powered data fusion engine can perform at least one of (1) cross-modality feature correlation to confirm the presence or absence of fentanyl derivatives, (2) spectral deconvolution to identify trace adulterants and precursors, and/or (3) pattern recognition to highlight chemical signatures tied to specific manufacturing routes.

In some implementations, the method 400 can result in chemical profiling, source attribution, and/or manufacturing process analysis that can be made available to multiple entities (e.g., agencies) through a secure cloud hub, enabling real-time collaboration among, for example, the Department of Homeland Security (DHS) and/or other federal entities, state authorities, and/or local authorities.

By delivering scalable, accurate, and operationally secure forensic capabilities, the method 400 can facilitate, for example, combat of the fentanyl supply chain. The hardware-agnostic configuration of the method 400 can ensure easy integration with compute devices, while a cloud-based platform-as-a-service (PaaS) can support cross-agency intelligence sharing without compromising data integrity. With real-time, on-site sample characterization, entities (e.g., law enforcement) can intervene faster, reduce distribution of lethal synthetic opioids, and/or strengthen prosecutions by establishing immediate evidentiary links. Collectively, these advantages can facilitate enhanced inter-agency collaboration, rapid disruption of trafficking routes, and/or improved public safety in the ongoing fight against the opioid epidemic.

In some implementations, the method 400 can integrate miniaturized HSI, Raman spectroscopy, and FTIR analysis with an AI-powered data fusion engine and secure PaaS backend. The method 400 can further include validating the integration of HSI, Raman spectroscopy, and FTIR analysis to provide complementary chemical and physical data for fentanyl analysis. In some instances, the method 400 can achieve >90% accuracy in chemical identification while maintaining rapid (<5-minute) analysis times. The AI-powered data fusion can involve trained machine learning (ML) algorithms for cross-modality feature correlation, spectral deconvolution, and/or batch differentiation. This data fusion engine can further integrate chemical and non-chemical signatures (e.g., surface texture, packaging characteristics) into actionable insights.

In some implementations, each analytical modality (HSI, Raman, FTIR) can be implemented by a portable and/or robust device (e.g., spectrometer) for field deployment. In some implementations, the method 400 involves a cloud-based PaaS backend component that is secure for real-time data processing, analytics, and/or intelligence sharing.

The method 400 can further include identifying key performance metrics associated with the AI-powered data fusion engine, such as, for example, accuracy, detection thresholds, data fusion reliability, and/or operational speed.

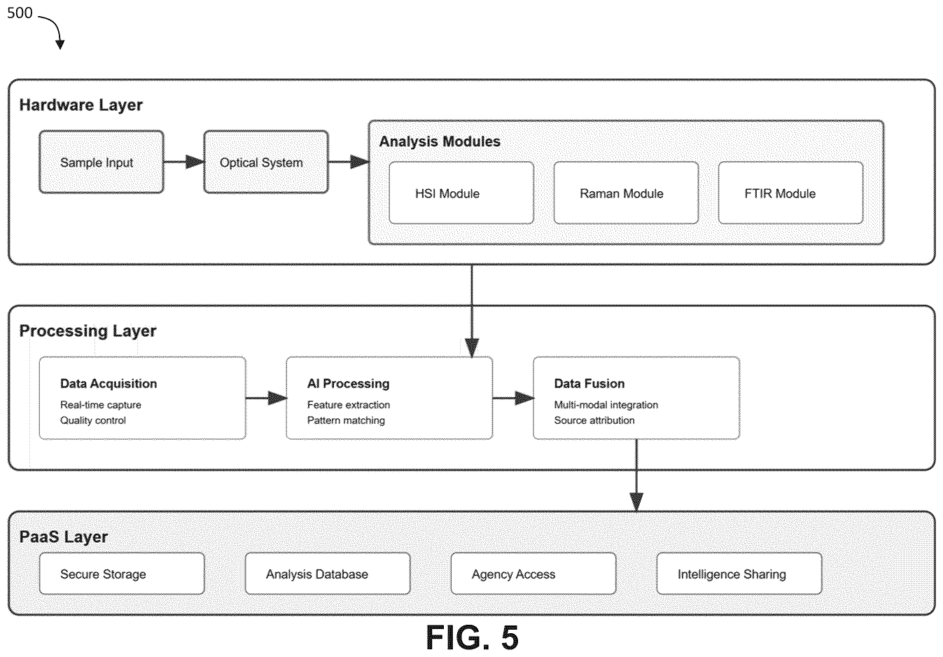

FIG. 5 shows a system block diagram of multimodal analysis layers 500 (e.g., multimodal analysis subsystems) implemented by a spectroscopy analysis system, according to an embodiment. At least a portion of the multimodal analysis layers 500 can be associated with a compute device (e.g., a compute device that is structurally and/or functionally similar to the compute device 201 of FIG. 2 and/or the compute devices 110 and 120 of FIG. 1). For example, the multimodal analysis layers 500 can include, be included in, implement, and/or be associated with (1) the spectroscopy analyzer 112 of FIG. 1 and/or (2) the spectroscopy analyzer 212 of FIG. 2. In some instances, the multimodal analysis layers 500 can include software stored in memory 210 and configured to execute via the processor 220 of FIG. 2. In some instances, at least a portion of the multimodal analysis layers 500 can be implemented in hardware (e.g., an ASIC) or a combination of hardware (e.g., a general-purpose processor) and software.

The multimodal analysis layers 500 can use a configuration of spectrometers that enables simultaneous (and/or concurrent, contemporaneous, etc.) data acquisition from a plurality of channels (also referred to herein as modalities/modes, where each modality/mode can be associated with a different spectrometer and/or spectroscopy technique. The modalities/modes can include, for example, three modalities/modes, including a hyperspectral image mode, a Raman spectrum mode, and an Fourier transform infrared spectrum mode, as described herein. The multimodal analysis layers 500 can analyze the resulting spectra data through a data processing pipeline that is implemented as, for example, a four-stage processing approach, as illustrated below with example processing times:
1. Raw Data Acquisition (30 seconds)
   Parallel data collection from all three modalities
   Real-time quality checks
   Automatic calibration
2. Primary Analysis (60 seconds)
   Spectral preprocessing
   Feature extraction
   Individual modality analysis
3. Data Fusion (30 seconds)
   Cross-modality feature correlation
   Weighted feature combination
   Uncertainty quantification
4. Results Generation (30 seconds)
   Source attribution
   Confidence scoring
   Report compilation

Example performance and validation metrics associated with the multimodal analysis layers 500 are illustrated below:

| | |
|---|---|
| Capability | Performance |

Detection Capabilities (Estimated)

| | | |
|---|---|---|
| Minimum Detectible Concentration | 0.1% | w/w |

| | |
|---|---|
| Linear Dynamic Range | 0.1-100% |
| Precision (RSD) | <3% |
| Accuracy | >90% |

Environmental Tolerance (Estimated)

| | | |
|---|---|---|
| Temperature Range | 0-40° | C. |

| | |
|---|---|
| Humidity | Up to 95% non-condensing |
| Shock Resistance | MIL-STD-810G compliant |

In some implementations, the multimodal analysis layers 500 can implement parallel data acquisition and edge computing integration. The parallel data acquisition capabilities can include simultaneous (or concurrent) spectral measurements, optimized optical path design, and/or real-time preprocessing. Edge computing integration can further enhance performance through on-device preliminary analysis, reduced data transmission requirements, and/or immediate (or contemporaneous) preliminary results.

In some embodiments, the multimodal analysis layers 500 can perform comprehensive source attribution through detailed analysis of both chemical markers and physical characteristics (e.g., via the processing layer). Chemical marker analysis can include examining synthesis route indicators, cutting agent signatures, trace element profiles, and/or isotopic ratios. Physical characteristics assessment can include crystal morphology analysis, tablet pressing patterns, microscopic surface features, and/or packaging material analysis. These combined capabilities can provide a thorough framework for identifying and tracking the origins of analyzed substances.

The PaaS layer can serve as a nexus for inter-agency collaboration and intelligence sharing, enabling coordination in, for example, the fight against fentanyl trafficking. The cross-agency data sharing facilitated by the PaaS layer can, in some embodiments, feature hierarchical access control through federal-level oversight dashboards, state-level coordination interfaces, local agency access points, and/or configurable sharing permissions based on jurisdiction and security clearance. In some implementations, secure data exchange protocols associated with the PaaS layer can incorporate FIPS 140-2 compliant encryption, zero-trust architecture implementation, blockchain based chain of custody tracking, and/or secure API gateways for inter-system communication. Real-time intelligence distribution can be facilitated through automated alert systems for matching samples across jurisdictions, geographic pattern recognition and mapping, trend analysis and early warning systems, and/or automated reporting to relevant agencies.

The collaborative analysis facilitated by the multimodal analysis layers 500 can include joint investigation tools that enable case linking across jurisdictions, collaborative analysis workspaces, digital evidence sharing, and/or multi-agency case management. Intelligence integration capabilities can connect to federal databases, state crime lab systems, customs and border protection data sharing, and/or support international law enforcement collaboration. Analytics and reporting functions can provide cross-jurisdictional pattern analysis, supply chain mapping, network analysis of distribution patterns, and/or automated trend reports and bulletins.

In some instances, operational benefits of the multimodal analysis layers 500 can include, for example, enhanced coordination through rapid identification of multi-jurisdiction cases, automated notification of relevant agencies, coordinated response planning, and/or resource sharing opportunities. The multimodal analysis layers 500 can achieve intelligence amplification through ML-based pattern recognition, predictive analytics for trafficking routes, historical data analysis, and/or risk assessment and prioritization. Efficiency improvements promoted by the multimodal analysis layers 500 can include reduced duplicate testing, streamlined information sharing, accelerated investigation timelines, and/or optimized resource allocation.

In some implementations, the multimodal analysis layers 500 can involve a cloud-native architecture with geographic redundancy, automatic scaling, and/or 24/7 availability. Security measures of the multimodal analysis layers 500 can encompass, for example, end-to-end encryption, multi-factor authentication, comprehensive audit logging, and/or regular security assessments. Integration capabilities of the multimodal analysis layers 500 can include standard API interfaces, custom connector development, legacy system support, and/or mobile device access.

In some implementations, the multimodal analysis layers 500 can achieve, for example, an overall fentanyl detection accuracy of 92% on test data, an F1 score of 0.91, and an AUC-ROC of 0.96. Inference time can average 0.8 seconds per sample with a peak memory usage of 2.1 GB during processing. These metrics represent an improvement for field-deployable forensic analysis systems, which can be achieved while maintaining the stringent requirements for accuracy and reliability in forensic applications.

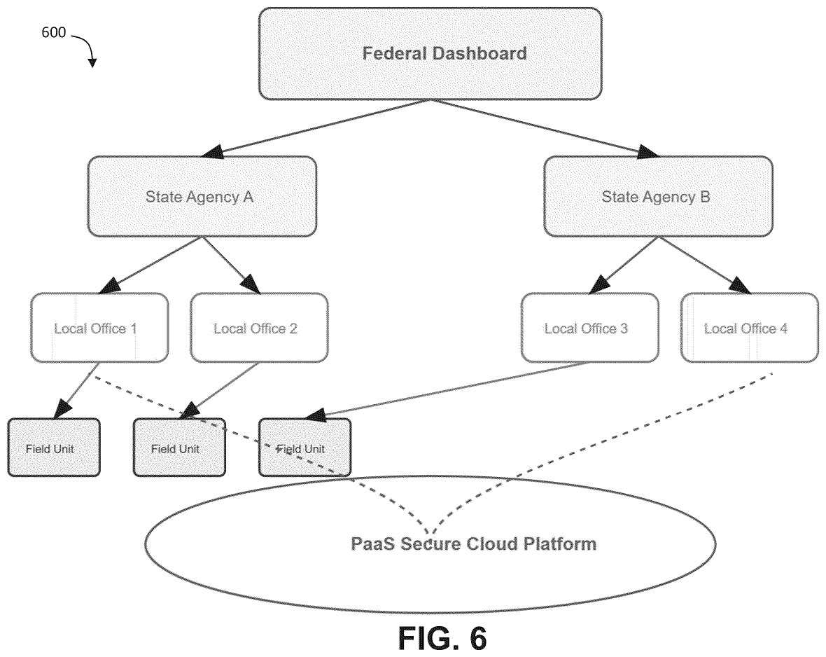

FIG. 6 shows a flow diagram illustrating a hierarchical dataflow 600 between federal, state, and local agency compute devices, according to an embodiment. In some instances, the hierarchical dataflow 600 can be implemented by a spectroscopy analysis system (e.g., the spectroscopy analysis system 100 of FIG. 1). Portions of the hierarchical dataflow 600 can be implemented using a processor (e.g., the processor 220 of FIG. 2) of any suitable compute device (e.g., the compute device 201 of FIG. 2 and/or the compute devices 110 and/or 120 and/or the server 130 of FIG. 1).

The hierarchical dataflow 600 can illustrate how a spectroscopy analysis system described herein can promote secure information sharing while maintaining appropriate access controls and data protection measures. As a result, the hierarchical dataflow 600 can facilitate cross-agency intelligence sharing with built-in chain-of-custody protections. For example, in some implementations, the hierarchical dataflow 600 can support a field-ready, cloud-integrated solution for DHS, other federal agencies, and/or the private sector. A PaaS backend described herein can offer flexible subscription tiers to law enforcement agencies, including secure data analytics, automated reporting, and/or real-time intelligence sharing.

While at least some methods and systems are described herein using fentanyl detection as an example use case, in some implementations, at least some methods and systems described herein can address, for example, other illicit substances (e.g., methamphetamine precursors, counterfeit pharmaceuticals), can serve public health, and/or can control manufacturing quality. More specifically, some systems and methods described herein can be applied in pharmaceutical counterfeiting prevention (e.g., to identify counterfeit drugs by analyzing chemical signatures and manufacturing patterns, ensuring the integrity of pharmaceutical supply chains), public health and safety (e.g., to detect synthetic opioids and other hazardous substances that can be leveraged for environmental monitoring and public health interventions, such as ensuring the safety of public spaces), industrial applications (e.g., to apply spectroscopic capabilities to quality control and contamination detection in manufacturing and/or food safety sectors), defense and security (e.g., to identify and mitigate risks related to chemical threats), and/or etc.

Turning now to Raman-based detection systems configured to detect, for example, pathogens, at least some methods and systems described herein can involve sample preparation and a robust AI/ML pipeline configured to handle high-dimensional spectral data.

FIG. 7 shows a system block diagram of hybrid analysis components 700 included in a spectroscopy analysis system, according to an embodiment. At least a portion of the hybrid analysis components 700 can be associated with a compute device (e.g., a compute device that is structurally and/or functionally similar to the compute device 201 of FIG. 2 and/or the compute devices 110 and 120 of FIG. 1). For example, the hybrid analysis components 700 can include, be included in, implement, and/or be associated with (1) the spectroscopy analyzer 112 of FIG. 1 and/or (2) the spectroscopy analyzer 212 of FIG. 2. In some instances, the multimodal analysis components 300 can include software stored in memory 210 and configured to execute via the processor 220 of FIG. 2. In some instances, at least a portion of the hybrid analysis components 700 can be implemented in hardware (e.g., an ASIC) or a combination of hardware (e.g., a general-purpose processor) and software.

The hybrid analysis components 700 include a data acquirer 710, a preprocessor 720, a hybrid analyzer 730, and a trainer 740. The preprocessor 720 includes a corrector 722, a smoother 724, and a normalizer 726. The hybrid analyzer 730 includes a feature extractor 732 and a classifier 734.

In some implementations, the hybrid analysis components 700 can be used to analyze a sample that has been prepared by, for example, culturing target pathogens under standardized conditions (e.g., on agar or in broth) to minimize biological variability. Cells can then be washed and placed onto gold-coated slides to reduce extraneous fluorescence and ensure consistent surface interactions for Raman measurements. A 785 nm laser with a Raman spectrometer (e.g., a Wasatch Photonics (WP-785X-F13-R-ILC-785 nm 10 C regulated Raman spectrometer) can be used with, for example, ~8 cm⁻¹ spectral resolution. This spectrometer can be functionally and/or structurally similar to the spectrometer 140 of FIG. 1. Each pathogen isolate can be sampled, for example, 10 or more times to capture within-strain heterogeneity.

The data acquirer 710 can be configured to acquire raw spectra data generated by the Raman spectrometer. This raw spectra data can include, for example, fluorescence backgrounds, shot noise, and/or baseline drift. The preprocessor 720 can therefore apply to the raw spectra data at least one of a baseline correction (e.g., using polynomial and/or rolling-circle methods via the corrector 722, to result in corrected spectrum data), noise smoothing (e.g., Savitzky-Golay filtering via the smoother 724, to result in smoothed spectrum data), and/or normalization (e.g., vector and/or total-area normalization via the normalizer 726, to result in normalized spectrum data), to ensure that downstream analyses focus on relevant biochemical peaks rather than instrumentation artifacts.

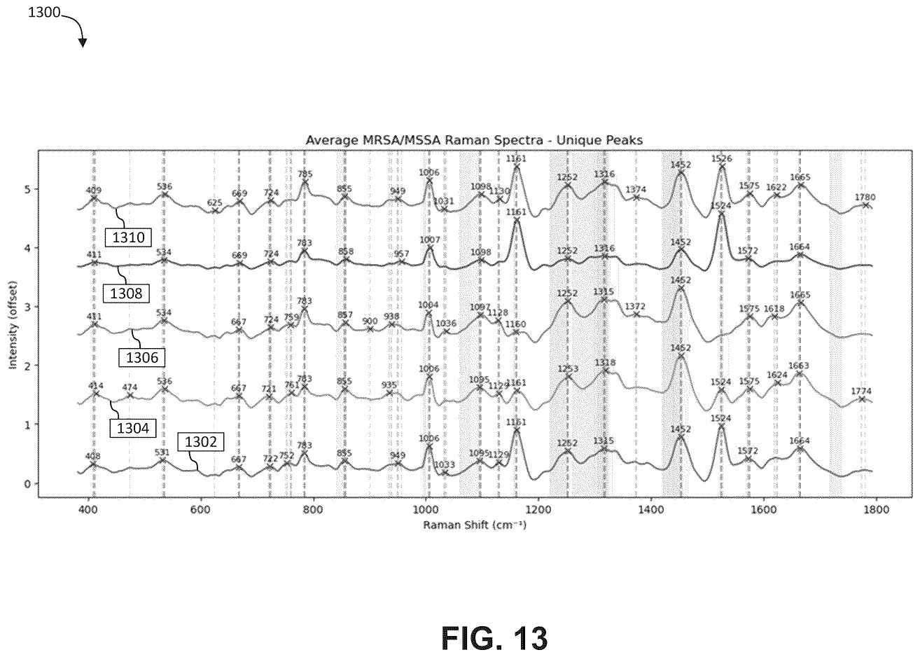

Following the data preprocessing, the hybrid analyzer 730 can apply a hybrid approach that combines feature extraction (via the feature extractor 732) and classification (via the classifier 734). The feature extractor 732 can be configured to perform principal component analysis (PCA) to reduce dimensionality of the preprocessed spectra data and highlight/amplify dominant spectral variations across multiple samples (e.g., resulting in dominant spectral variation data, described further herein at least in relation to FIG. 13). The feature extractor 732 can then use autoencoder networks (e.g., having convolutional layers) to capture subtle, non-linear features that the PCA might have missed. The autoencoders can compress spectra into a lower dimensional latent space (e.g., to result in embedded data), mitigating noise and improving classification robustness.

The classifier 734 can include (or have access to) a convolutional neural network (CNN) configured to learn local spectral signatures. More specifically, the classifier 734 can use convolutional kernels to capture peak shifts in the vibrational fingerprint region, building hierarchical feature representations. In some implementations, classifier 734 can include (or have access to) (1) a support vector machine (SVM) with a radial basis function (RBF) kernel and/or (2) a Random Forest (RF) (e.g., with 100-200 trees), which can improve detection when combined with features from PCA and/or autoencoder-derived embeddings.

Turning to the trainer 740, to ensure statistically sound results and guard against overfitting, particularly in smaller or highly imbalanced datasets, the trainer 740 can be configured to perform k-fold cross-validation (e.g., where k=5, 10, etc.). In each fold, the trainer 740 can split input data (e.g., spectra data) into training and validation/test sets, cycling through all data so that every sample eventually appears in a test set. For example, as shown in FIG. 7, the trainer 740 can cause the data acquirer 710 to provide a subset of raw spectra data to the preprocessor 720, such that a subset of preprocessed spectra data can be provided to the hybrid analyzer 730 for either training or validation. During training of the feature extractor 732 and/or the classifier 734, the trainer 740 can finetune hyperparameters (e.g., learning rates, regularization terms, kernel parameters for SVM, tree counts for RF, and/or etc.) based on outputs from the hybrid analyzer 730, using, for example, grid and/or random search. The trainer 740 can be further configured to examine stopping criteria based on validation loss to prevent or reduce overfitting.

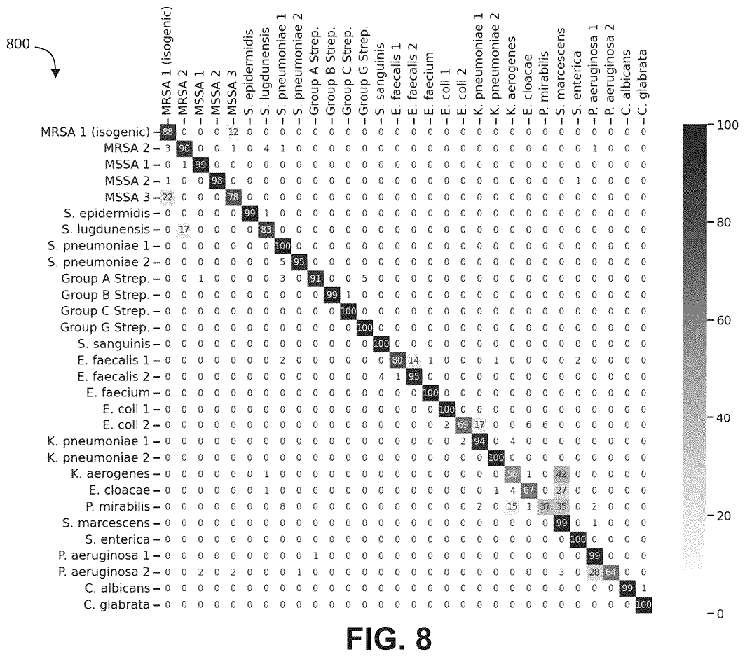

FIG. 8 shows a confusion matrix 800 that represents performance of a machine learning model(s) associated with a spectroscopy analysis system, according to an embodiment. The machine learning model(s) can be associated with (e.g., accessible by), for example, the feature extractor 732 and/or the classifier 734 of FIG. 7. The confusion matrix 800 can represent, for example, a panel of 30 diverse bacterial species (e.g., having 50-100 replicates per species, totaling 2,000 samples across the 30 classes to capture the natural biological variability). The Raman spectra represented by the confusion matrix 800 can have undergone at least one of baseline correction, smoothing, and/or normalization before being passed to the machine learning model(s), as described herein.

The confusion matrix 800 shows that the majority of errors (e.g., detection/classification errors) produced by the machine learning model(s) were isolated to closely related taxa that share similar biochemical compositions (e.g., minor misclassifications within Enterobacteriaceae). In contrast, more phylogenetically distant species were nearly always correctly identified. This performance underscores the usefulness of deep-feature extraction in capturing subtle vibrational signatures in Raman spectra. Moreover, these results highlight the capability of at least some systems and methods described herein to build a broad-spectrum database, encompassing multiple genera and species, so that new or emerging pathogens can be classified rapidly if their spectra fall within known distribution patterns.

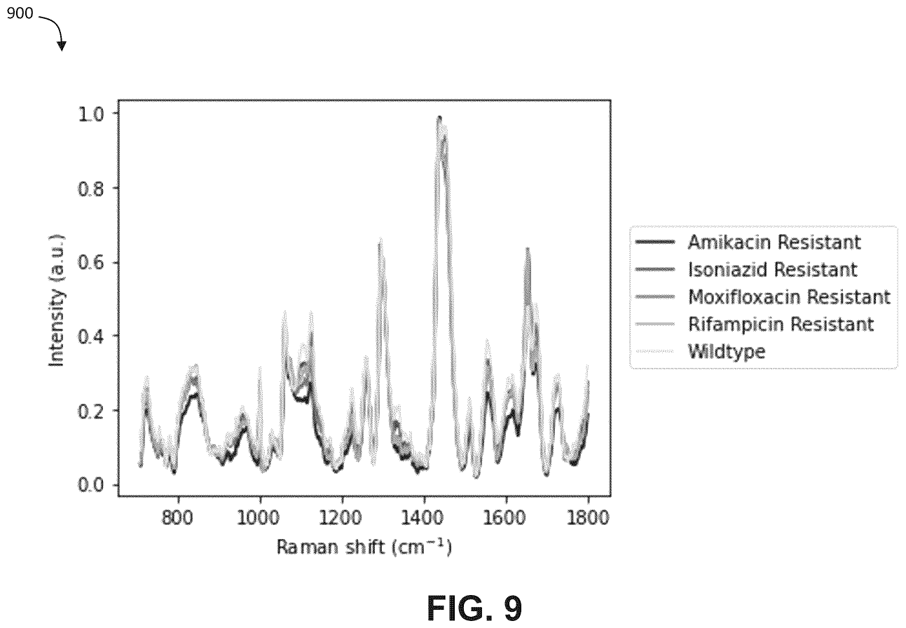

FIG. 9 shows a representation 900 of strains of antibiotic-resistant tuberculosis bacteria (e.g., Mycobacterium tuberculosis) analyzed by a spectroscopy analysis system, according to an embodiment. Classifying multidrug-resistant (MDR) vs. drug-sensitive strains of Tuberculosis can be difficult using some known methods due to the complex cell wall of Mycobacterium tuberculosis, characterized by high lipid content and mycolic acids, which can make rapid phenotypic detection challenging.

The dataset represented in FIG. 9 includes five different strains/classes of Tuberculosis resistant to different antibiotics. Each class includes 1702 samples and were scanned on a spectrometer (e.g., a Horiba® spectrometer) with a laser activation at 633 nm and laser power of 13.17 mW. FIG. 9 shows more specifically the background corrected spectral data of each class. Additionally, the representation 900 illustrates clinical samples the same 5 classes of antibiotic-resistant Tuberculosis from mucus samples derived from clinic settings, modeled by at least some systems and methods described herein. This dataset includes 2952 samples scanned with a laser activation of 785 nm at 2.53 mW. The models were trained using 10 random holdout cross validation sets with 70% training, 10% validation, and 20% test set split. Final accuracy was found by averaging the test set accuracy of all 10 models. Lab samples model performance had an accuracy of 99.8%, and clinical samples model performance had an accuracy of 90.5%.

To evaluate the efficacy in an industrial context of at least some systems and methods described herein, the detection of Listeria monocytogenes, Escherichia coli, and Salmonella enterica in lab and environmental swab samples can be used. Results show that these pathogens were consistently identified with approximately 95% accuracy, and the total time to achieve result spanning sample preparation, spectral acquisition, and classification—was substantially shorter than some known techniques, such as some known culture-based methods, which typically span 24-48 hours or longer for bacterial growth and confirmation.

In practical terms, these findings illustrate the potential for Raman-AI systems such as those described herein to serve as near-real-time screening tools on production lines, allowing for rapid intervention if contamination is detected. The high sensitivity (recall) observed is particularly pivotal for food safety, given that missing even a single contaminated sample can have significant public health ramifications. Together, these results underscore the versatility of the Raman-AI pipeline in addressing both clinical and food-safety challenges through fast, accurate, and label-free bacterial identification.

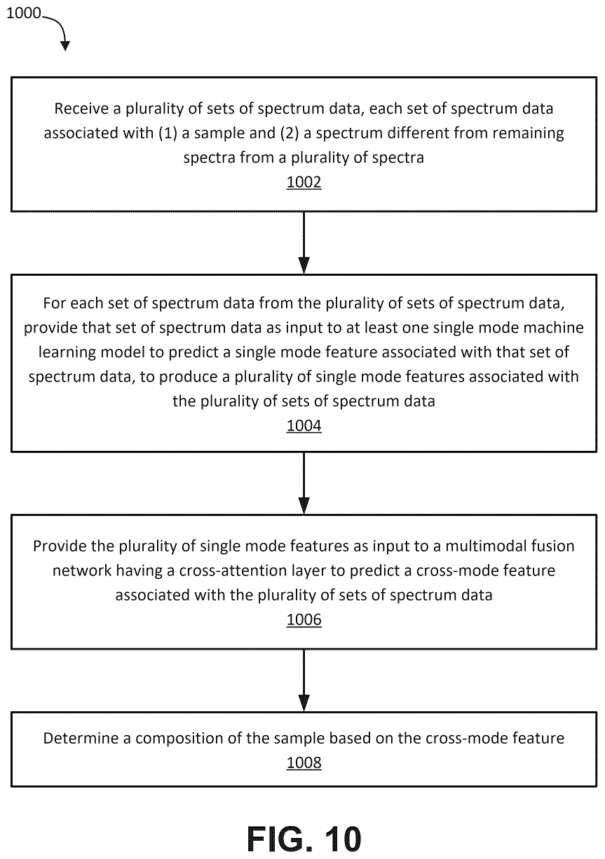

FIG. 10 shows a flow diagram illustrating a method 1000 for determining a composition of a sample based on a cross-mode feature, according to an embodiment. In some instances, the method 1000 can be implemented by a spectroscopy analysis system (e.g., the spectroscopy analysis system 100 of FIG. 1). Portions of the method 1000 can be implemented using a processor (e.g., the processor 220 of FIG. 2) of any suitable compute device (e.g., the compute device 201 of FIG. 2 and/or the compute devices 110 and/or 120 and/or the server 130 of FIG. 1).

The method 1000 at 1002 includes receiving a plurality of sets of spectrum data, each set of spectrum data associated with (1) a sample and (2) a spectrum different from remaining spectra from a plurality of spectra. At 1004, the method 1000 includes, for each set of spectrum data from the plurality of sets of spectrum data, provide that set of spectrum data as input to at least one single mode machine learning model to predict a single mode feature associated with that set of spectrum data, to produce a plurality of single mode features associated with the plurality of sets of spectrum data. The plurality of single mode features is provided at 1006 as input to a multimodal fusion network having a cross-attention layer to predict a cross-mode feature associated with the plurality of sets of spectrum data. A composition of the sample is determined at 1008 based on the cross-mode feature.

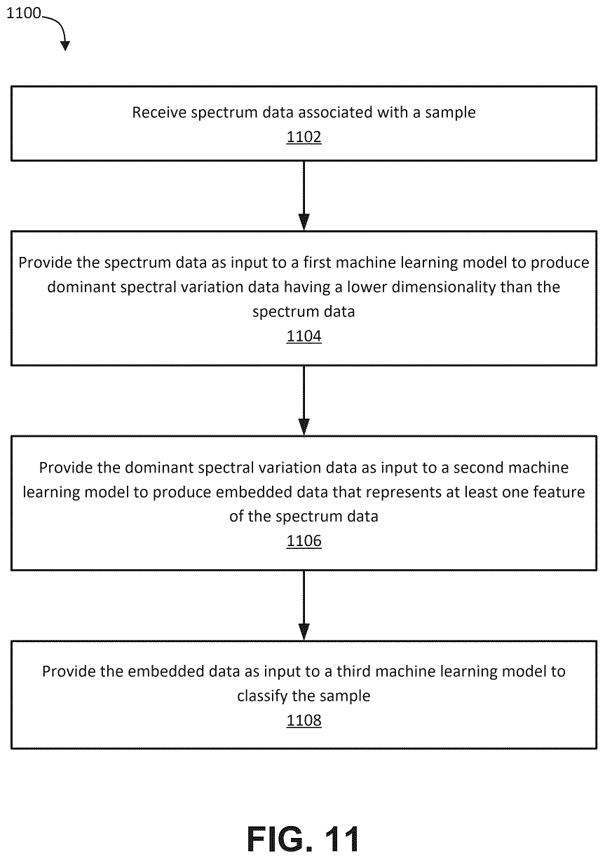

FIG. 11 shows a flow diagram illustrating a method 1100 for classifying a sample based on Raman spectrum data, according to an embodiment. In some instances, the method 1100 can be implemented by a spectroscopy analysis system (e.g., the spectroscopy analysis system 100 of FIG. 1). Portions of the method 1100 can be implemented using a processor (e.g., the processor 220 of FIG. 2) of any suitable compute device (e.g., the compute device 201 of FIG. 2 and/or the compute devices 110 and/or 120 and/or the server 130 of FIG. 1).

The method 1100 at 1102 includes receiving spectrum data associated with a sample and, at 1104, providing the spectrum data as input to a first machine learning model to produce dominant spectral variation data having a lower dimensionality than the spectrum data. The method 1100 at 1106 includes providing the dominant spectral variation data as input to a second machine learning model to produce embedded data that represents at least one feature of the spectrum data. The embedded data is provided as input to a third machine learning model at 1108 to classify the sample.

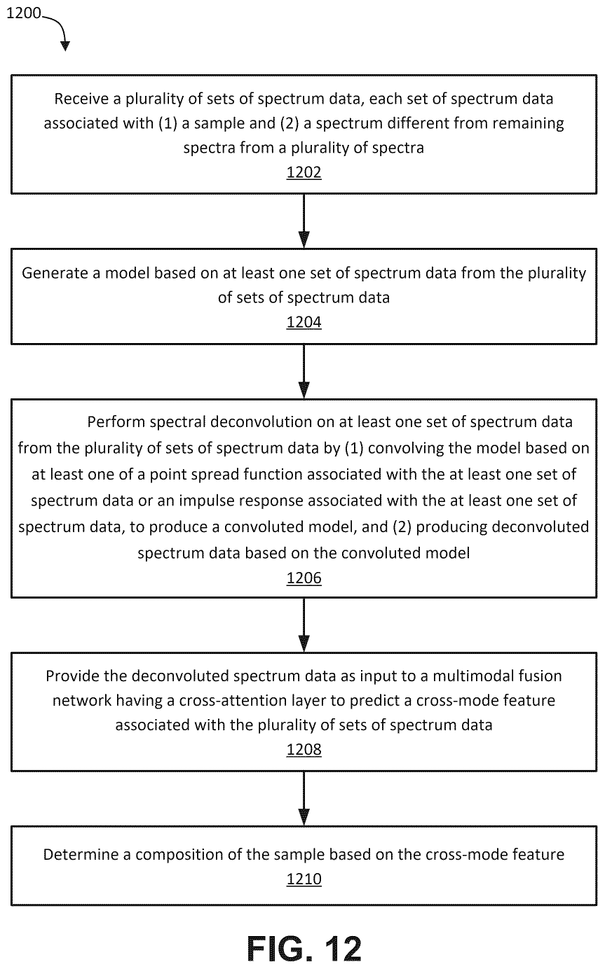

FIG. 12 shows a flow diagram illustrating a method 1200 for determining a composition of a sample based on deconvoluted spectrum data, according to an embodiment. In some instances, the method 1200 can be implemented by a spectroscopy analysis system (e.g., the spectroscopy analysis system 100 of FIG. 1). Portions of the method 1200 can be implemented using a processor (e.g., the processor 220 of FIG. 2) of any suitable compute device (e.g., the compute device 201 of FIG. 2 and/or the compute devices 110 and/or 120 and/or the server 130 of FIG. 1).

The method 1200 at 1202 includes receiving a plurality of sets of spectrum data, each set of spectrum data associated with (1) a sample and (2) a spectrum different from remaining spectra from a plurality of spectra. At 1204, the method 1200 includes generating a model based on at least one set of spectrum data from the plurality of sets of spectrum data. At 1206, spectral deconvolution is performed on at least one set of spectrum data from the plurality of sets of spectrum data by (1) convolving the model based on at least one of a point spread function associated with the at least one set of spectrum data or an impulse response associated with the at least one set of spectrum data, to produce a convoluted model, and (2) producing deconvoluted spectrum data based on the convoluted model. The deconvoluted spectrum data is provided as input at 1208 to a multimodal fusion network having a cross-attention layer to predict a cross-mode feature associated with the plurality of sets of spectrum data, and a composition of the sample is determined at 1210 based on the cross-mode feature.

FIG. 13 shows a graph 1300 of Raman spectral profiles (e.g., average Raman spectral profiles) for five strains of Staphylococcus Aureus, according to an embodiment. The five strains include two methicillin-resistant Staphylococcus Aureus strains (MRSA), represented in graph 1300 by profiles 1302 and 1304, and three methicillin-susceptible Staphylococcus Aureus strains (MSSA), represented in graph 1300 by profiles 1306, 1308, and 1310. The profiles 1302-1310 of the graph 1300 can represent dominant spectral variations (e.g., that are amplified by a feature extractor that is functionally and/or structurally similar to the feature extractor 732 of FIG. 7). For example, a dominant spectral variation can be represented by a peak, peak shift, peak to peak ratio, peak to trough ratio, 1^{st} derivative, and/or 2^{nd} derivative, of a signal waveform associated with a profile 1302-1310. A dominant spectral variation can improve classification performed by a classifier that is functionally and/or structurally similar to the classifier 734 of FIG. 7.

More specifically, for example, the graph 1300 can illustrate that methicillin resistant strains of Staphylococcus aureus show higher intensities (an example of a dominant spectral variation) at ~1290 cm⁻¹ as compared to methicillin susceptible strains, due to differences in amide III proteins. Graph 1300 further illustrates carbon-hydrogen (CH) deformation profiles (a further example of a dominant spectral variation) in the 1300-1350 cm⁻¹ range.

Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java, JavaScript, C++, and/or other programming languages and development tools. Additional examples of computer code include, but are not limited to, control signals, encrypted code, and compressed code.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium and/or a machine-readable medium) having instructions or computer code thereon for performing various computer-implemented operations. The computer-readable medium (or processor-readable medium, machine-readable medium, etc.) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules can include, for example, a processor, a field programmable gate array (FPGA), and/or an application specific integrated circuit (ASIC). Software modules (executed on hardware) can include instructions stored in a memory that is operably coupled to a processor and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

What is claimed is:

1. A non-transitory, processor-readable medium storing instructions that, when executed by a processor, cause the processor to:
receive a plurality of sets of spectrum data, each set of spectrum data associated with (1) a sample and (2) a spectrum different from remaining spectra from a plurality of spectra;
for each set of spectrum data from the plurality of sets of spectrum data, provide that set of spectrum data as input to at least one single mode machine learning model to predict a single mode feature associated with that set of spectrum data, to produce a plurality of single mode features associated with the plurality of sets of spectrum data;
provide the plurality of single mode features as input to a multimodal fusion network having a cross-attention layer to predict a cross-mode feature associated with the plurality of sets of spectrum data; and
determine a composition of the sample based on the cross-mode feature.

2. The non-transitory, processor-readable medium of claim 1, wherein the plurality of sets of spectrum data includes:
hyperspectral image data representing a wavelength band for each pixel from a plurality of pixels represented by the hyperspectral image data;
Raman spectrum data; and
Fourier transform infrared (FTIR) spectrum data.

3. The non-transitory, processor-readable medium of claim 1, wherein the at least one single mode machine learning model includes a convolutional neural network.

4. The non-transitory, processor-readable medium of claim 1, further storing instructions to cause the processor to:
generate a model based on at least one set of spectrum data from the plurality of sets of spectrum data; and
perform spectral deconvolution on the at least one set of spectrum data based on the model to produce deconvoluted spectrum data, the cross-mode feature being predicted based on the deconvoluted spectrum data.

5. The non-transitory, processor-readable medium of claim 1, further storing instructions to cause the processor to:
perform source attribution of the sample based on the cross-mode feature representing at least one of a synthesis route indicator, a cutting agent signature, a trace element profile, an isotopic ratio, a crystal morphology, a tablet pressing pattern, a microscopic surface feature, or a packaging material characteristic.

6. The non-transitory, processor-readable medium of claim 1, further storing instructions to cause the processor to:
track a chain of custody associated with the sample by causing the composition of the sample to be recorded on a blockchain.

7. A non-transitory, processor-readable medium storing instructions that, when executed by a processor, cause the processor to:
receive spectrum data associated with a sample;
provide the spectrum data as input to a first machine learning model to produce dominant spectral variation data having a lower dimensionality than the spectrum data;
provide the dominant spectral variation data as input to a second machine learning model to produce embedded data that represents at least one feature of the spectrum data; and
provide the embedded data as input to a third machine learning model to classify the sample.

8. The non-transitory, processor-readable medium of claim 7, wherein:
the spectrum data includes Raman spectrum data produced by a Raman spectrometer.

9. The non-transitory, processor-readable medium of claim 7, wherein:
the first machine learning model is configured to perform principal component analysis (PCA).

10. The non-transitory, processor-readable medium of claim 7, wherein:
the second machine learning model includes an autoencoder having a convolutional layer.

11. The non-transitory, processor-readable medium of claim 7, wherein:
the third machine learning model includes a convolutional neural network (CNN).

12. The non-transitory, processor-readable medium of claim 7, wherein:
the third machine learning model includes a support vector machine (SVM) having a radial basis function (RBF) kernel.

13. The non-transitory, processor-readable medium of claim 7, further storing instructions to cause the processor to:
perform at least one of a polynomial-based baseline correction or a rolling circle-based baseline correction on raw spectrum data to produce the spectrum data.

14. The non-transitory, processor-readable medium of claim 7, further storing instructions to cause the processor to:
perform Savitzky-Golay filtering on raw spectrum data to produce the spectrum data.

15. The non-transitory, processor-readable medium of claim 7, further storing instructions to cause the processor to:
perform at least one of vector normalization or total-area normalization on raw spectrum data to produce the spectrum data.

16. The non-transitory, processor-readable medium of claim 7, further storing instructions to cause the processor to:
split the embedded data into training data and validation data, based on a predetermined number of folds; and
perform k-fold cross-validation on the third machine learning model across the predetermined number of folds and based on the training data and validation data, to finetune at least one of a learning rate, a regularization term, or a kernel parameter, associated with the third machine learning model.

17. The non-transitory, processor-readable medium of claim 7, wherein:
the sample includes a pathogen; and
the instructions to cause the processor to classify the sample include instructions to cause the processor to determine if the pathogen is antibiotic-resistant.

18. The non-transitory, processor-readable medium of claim 7, wherein:
the sample includes a plurality of pathogen cells that have been washed and placed onto a gold-coated slide.

19. A non-transitory, processor-readable medium storing instructions that, when executed by a processor, cause the processor to:
receive a plurality of sets of spectrum data, each set of spectrum data associated with (1) a sample and (2) a spectrum different from remaining spectra from a plurality of spectra;
generate a model based on at least one set of spectrum data from the plurality of sets of spectrum data;
perform spectral deconvolution on at least one set of spectrum data from the plurality of sets of spectrum data by:
convolving the model based on at least one of a point spread function associated with the at least one set of spectrum data or an impulse response associated with the at least one set of spectrum data, to produce a convoluted model, and
producing deconvoluted spectrum data based on the convoluted model;
provide the deconvoluted spectrum data as input to a multimodal fusion network having a cross-attention layer to predict a cross-mode feature associated with the plurality of sets of spectrum data; and
determine a composition of the sample based on the cross-mode feature.

20. The non-transitory, processor-readable medium of claim 19, further storing instructions to cause the processor to:
perform source attribution of the sample based on the cross-mode feature representing at least one of a synthesis route indicator, a cutting agent signature, a trace element profile, an isotopic ratio, a crystal morphology, a tablet pressing pattern, a microscopic surface feature, or a packaging material characteristic.

21. The non-transitory, processor-readable medium of claim 19, wherein the instructions to cause the processor to generate the model include instructions to cause the processor to:
generate, based on the at least one set of spectrum data, the model that represents at least one of a Gaussian shape or a Lorentzian shape.
